(19) United States
(12) Patent Application Publication
(10) Pub. No.: US 2016/0010712 A1
(43) Pub. Date: Jan. 14, 2016

(54) Method and Apparatus for Producing a Brake Lining, Brake Lining

(71) Applicant: Robert Bosch GmbH, Stuttgart (DE)

(72) Inventor: Peter Rothacher, Bruchsal (DE)

(21) Appl. No.: 14/790,523

(22) Filed: Jul. 2, 2015

(30) Foreign Application Priority Data
Jul. 10, 2014 (DE) 10 2014 213 395.5

(51) Int. Cl. F16D 69/02

(52) U.S. Cl. CPC F16D 69/02; F16D 69/026; F16D 69/028

(57) ABSTRACT

A method for producing a brake lining, including a multiplicity of fibers, for a braking device. The fibers in the brake lining are aligned at least substantially perpendicularly to a braking surface of the brake lining

This application claims priority under 35 U.S.C. §119 to patent application number DE 10 2014 213 395.5, filed on Jul. 10, 2014 in Germany, the disclosure of which is incorporated herein by reference in its entirety.

### BACKGROUND

The disclosure relates to a method for producing a brake lining for a braking device, in particular of a motor vehicle, the brake lining being provided with a multiplicity of fibers.

The disclosure also relates to an apparatus for producing a brake lining for a braking device, in particular of a motor vehicle, in particular for carrying out the aforementioned method, comprising a molding device.

The disclosure also relates to a brake lining for a braking device, in particular of a motor vehicle, in particular produced by the aforementioned method, in particular by means of the aforementioned apparatus, a multiplicity of fibers being incorporated in the brake lining.

In motor vehicle construction, various types of brake linings are used for various types of motor vehicles. In particular, metallic, low-metallic and ceramic brake linings are often used. The two first-mentioned types are often used in particular in the European region. In order to increase the friction of the brake lining and/or in order to distribute the heat produced by friction during braking better in the brake lining, it is known to provide fibers in the brake lining

### SUMMARY

The method according to the disclosure with the features described herein has the advantage that the brake lining produced by the method according to the disclosure avoids instances of local overheating, in particular at the friction surface of the brake lining, and dissipates the heat advantageously into the brake lining, at the same time the friction at the friction surface or the friction coefficient applicable there being increased. According to the disclosure, this is achieved by the fibers in the brake lining being aligned at least substantially perpendicularly to the braking surface of the brake lining Metallic fibers or else ceramic fibers may be used for example as fibers, the former particularly enhancing the heat dissipation and the latter the friction coefficient.

According to an advantageous development of the disclosure, it is provided that the brake lining is produced in a molding process, the fibers being aligned in the molding compound forming the brake lining before or during the molding process. This achieves the effect that, when the molding process is completed, the fibers are in the desired alignment and the brake lining has the aforementioned advantageous properties. Particularly before and during the molding process, while the brake lining itself is still in the deformable state, the fibers allow themselves to be aligned without great expenditure of force.

It is provided with preference that magnetic or magnetizable fibers are used and are aligned by a magnetic field. This allows the fibers to be contactlessly brought into the desired alignments in the brake lining before or during the molding process. For this purpose, the magnetic field merely has to be strong enough to displace the fibers in the molding compound. Furthermore, the magnetic field must be formed in such a way that the fibers align themselves in the desired alignment perpendicularly to the friction surface or later friction surface. In this respect it is advantageous for example if the source of the magnetic field is arranged at a sufficient distance from the mold, so that the magnetic field lines of the magnetic field at which the fibers align themselves with preference extend as far as possible perpendicularly through the brake lining. Metallic fibers, in particular steel fibers, are used with particular preference as fibers.

Furthermore, it is provided with preference that the magnetic field is set by an energizable coil, in particular by a Helmholtz coil. The energizing of the coil allows the strength of the magnetic field to be varied and the alignment of the fibers, in particular steel fibers, to be influenced.

Alternatively, it is provided with preference that, to generate the magnetic field, pairs of molds for the molding process that are lying opposite one another are magnetized. As a result, the steel fibers are automatically aligned over the molding process, by the pairs of molds lying opposite one another and the magnetic field extending in between.

The apparatus according to the disclosure with the features described herein is distinguished by the fact that it has a device for aligning fibers in the brake lining at least substantially perpendicularly to a braking surface or a friction surface of the brake lining In this way, the advantages already mentioned above are obtained. In particular, it is provided that the device is a device for generating a magnetic field in order to align magnetic or magnetizable fibers, in particular steel fibers, appropriately.

The device is preferably configured as an energizable Helmholtz coil.

Alternatively, it is provided with preference that the device has an electromagnet for magnetizing mold halves lying opposite one another of the molding device.

The brake lining according to the disclosure with the features described herein is distinguished by the fact that fibers in the brake lining are aligned at least substantially perpendicularly to a braking surface of the brake lining In this way, the advantages already mentioned above are obtained. Further embodiments and advantages of the disclosure emerge from the foregoing description.

### BRIEF DESCRIPTION OF THE DRAWINGS

The disclosure is to be explained in more detail below on the basis of an exemplary embodiment, in which:

FIG. 1 shows an apparatus for producing a brake lining before it is put into operation and

FIG. 2 shows the apparatus while it is being put into operation.

### DETAILED DESCRIPTION

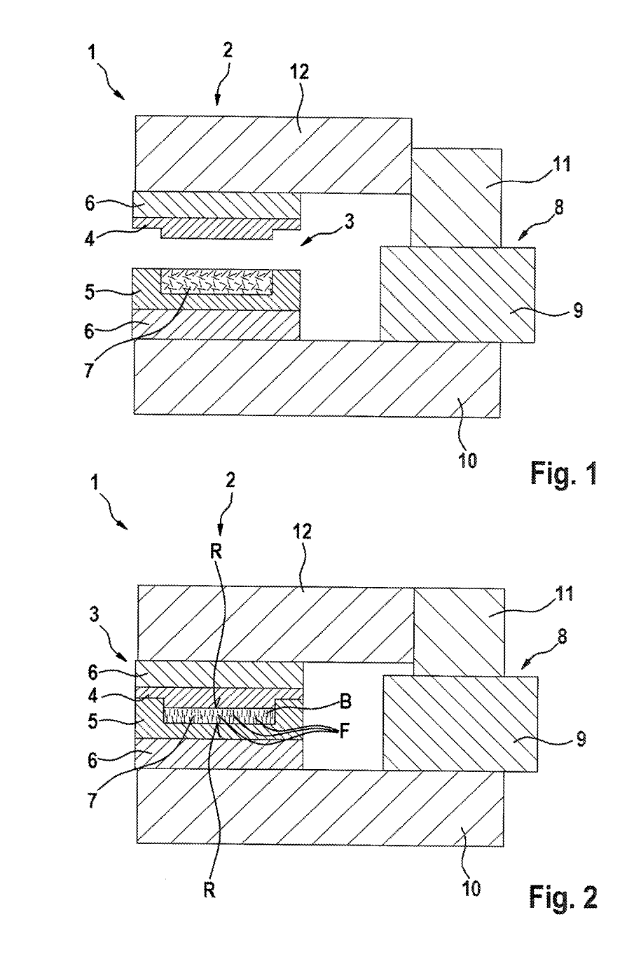

FIG. 1 shows in a simplified sectional representation an apparatus 1 for producing a brake lining B, in particular for a motor vehicle. The apparatus 1 has a molding device 2, which has a two-part mold 3, which has two mold parts 4 and 5 lying opposite one another. The mold parts 4, 5 are in this case respectively assigned a heating device 6. The mold part 5 has a receptacle, into which molding compound 7 has been introduced. The molding compound 7 is for example a metallic compound for producing the brake lining B. The molding compound 7 is also provided with a multiplicity of steel fibers F. The other mold part 4 has a male die part, which can be pressed into the receptacle of the mold part 5 in order to compress and shape the molding compound 7 therein. The mold part 4 is to this extent movable toward the mold part 5.

Furthermore, the apparatus 1 has a device 8 for generating a magnetic field. In the present case, the device 8 is configured as an electromagnet 9. The electromagnet 9 is connected to the molding device 2 in such a way that a magnetic flux is generated through housing parts 10, 11 and 12, the housing parts 10 and 12 being arranged to lie opposite one another and the housing part 11 conducting the magnetic flux from the housing part 10 to the housing part 12 through the electromagnet 9. The housing part 12 is in this case configured such that it can be made to move with the mold part 4.

If the molding device 2 is closed, as shown in FIG. 2, the housing parts 12 and 10 also move closer together, whereby an air gap between the mold parts 4 and 5, which are preferably themselves not configured to be magnetic, is reduced, so that the magnetic flux generated by the electromagnet 9 is conducted through the molding compound 7. As a result, the steel fibers F located in the molding compound 7 are aligned at the magnetic flux lines of the magnetic field. The mold parts 4, 5 are configured in such a way that the later braking surfaces of the brake lining are aligned perpendicularly to the magnetic flux lines, as shown in FIG. 2. This has the effect that the steel fibers F in the brake lining B are aligned perpendicularly to the later braking surfaces R.

The brake lining B produced in this way has increased friction coefficients at the braking surfaces R and at the same time ensures advantageous heat dissipation from the braking surfaces R into the brake lining B. The orientation of the steel fibers F predominantly perpendicularly to the braking surface R means that the friction of the brake lining B is increased in comparison with known brake linings B containing the same proportion by mass and at the same time that braking heat is dissipated better into the lining B, which reduces instances of local overheating, friction-reducing carbonization and the wear caused by local overheating. The orientation of further fiber components in the brake lining can likewise lead to or be used for increasing the friction coefficient.

The fiber components, in particular the steel fibers F, are oriented or aligned in relation to the braking surface R before or during the molding process, as described above. Tests have shown that the proportion of the steel fibers F with a deviation of less than 15° from the perpendicular alignment in relation to the braking surface is over 50%. Depending on the strength of the magnetic field, it has been possible to increase the proportion to over 70% and even to over 90%. With temporarily or permanently magnetizable steel fibers F, the alignment of the steel fibers F can also be performed in a Helmholtz coil.

As an alternative to steel fibers, it is also conceivable in principle to provide other types of fibers, in particular those that allow themselves to be aligned in the magnetic field.

What is claimed is:

1. A method for producing a brake lining for a braking device, the brake lining including a multiplicity of fibers, the method comprising:
aligning the fibers in the brake lining at least substantially perpendicularly to a braking surface of the brake lining.

2. The method according to claim 1, further comprising:
forming the brake lining in a molding process,
wherein the fibers are aligned in a molding compound which forms the brake lining before or during the molding process.

3. The method according to claim 2, wherein:
the fibers are configured to be magnetic or magnetisable, and
the fibers are aligned by a magnetic field.

4. The method according to claim 3, further comprising:
setting the magnetic field by an energizable coil.

5. The method according to claim 3, further comprising:
magnetizing mold parts of a molding device for the molding process to generate the magnetic field.

6. An apparatus for producing a brake lining for a braking device, the apparatus comprising:
a molding device; and
at least one device configured to align fibers in the brake lining at least substantially perpendicularly to a braking surface of the braking device.

7. The apparatus according to claim 6, wherein the at least one device is configured to generate a magnetic field.

8. The apparatus according to claim 6, wherein the at least one device is configured as an energizable coil.

9. The apparatus according to claim 6, wherein the at least one device has an electromagnet configured to magnetize mold halves of the molding device.

10. A brake lining for a braking device, the brake lining comprising:
a braking surface; and
a multiplicity of fibers incorporated in the brake lining,
wherein the fibers are aligned at least substantially perpendicularly to the braking surface.

11. The method of claim 1, wherein the brake lining is configured for use in a motor vehicle.

12. The method of claim 4, wherein the energizable coil is a Helmholtz coil.

13. The apparatus of claim 6, wherein the brake lining is configured for use in a motor vehicle.

14. The apparatus of claim 8, wherein the energizable coil is a Helmholtz coil.

15. The brake lining of claim 10, wherein the fibers are magnetic or magnetisable.

16. The brake lining of claim 15, wherein the fibers are configured to be aligned by a magnetic field.

17. The brake lining of claim 16, wherein the magnetic field is set by an energizable coil.

18. The brake lining of claim 17, wherein the energizable coil is a Helmholtz coil.

19. The brake lining of claim 10, wherein the brake lining is configured to be used in a motor vehicle.
